(19) United States
(12) Patent Application Publication
(10) Pub. No.: US 2014/0261252 A1
(43) Pub. Date: Sep. 18, 2014

(54) PRESSURE INDUCED CYLINDRICAL GAS GENERATOR SYSTEM FOR THE ELECTROLYSIS OF AMMONIUM HYDROXIDE

(71) Applicant: CFT Global, LLC., Denver, CO (US)

(72) Inventor: Kenny Kerstiens, Denver, CO (US)

(73) Assignee: CFT Global, LLC., Denver, CO (US)

(21) Appl. No.: 14/216,707

(22) Filed: Mar. 17, 2014

Related U.S. Application Data
(60) Provisional application No. 61/792,641, filed on Mar. 15, 2013.

(51) Int. Cl. F02B 51/04; C25B 1/00; C25B 1/02; F02M 21/02; C25B 9/00

(52) U.S. Cl. CPC F02B 51/04; F02M 21/0206; C25B 9/00; C25B 1/02; C25B 1/00
USPC 123/3; 204/278; 205/637; 205/633; 205/615

(57) ABSTRACT

A combination air pressure system and a gas generator system adapted for mounting next to an intake manifold of a turbocharged diesel engine. The system includes a solution reservoir tank for supplying a fluid mixture to a gas generator. The gas generator includes a housing with a plurality concentric tubular electrodes consisting of both anode and cathode tubular electrodes with a series of interposed bipolar electrodes.

### CROSS-REFERENCE TO RELATED APPLICATIONS

This application claims priority to and the benefit of U.S. provisional application No. 61/792,641, entitled “Pressure Induced Cylindrical Gas Generator System For the Electrolysis of Ammonium Hydroxide”, which was filed on Mar. 15, 2013, and which is hereby incorporated by reference in its entirety for all purposes.

### TECHNICAL FIELD

The present disclosure is generally directed to a pressurized gas generation system used to improve the performance of an engine.

### BACKGROUND

Heretofore, there have been a large number of prior art references directed to hydrogen gas generation for internal combustion engines. These references disclose complex and expensive apparatus and methods for generating hydrogen gas using an electrolysis cell and may even require a major redesign of a standard diesel engine and the engine's exhaust system.

### SUMMARY

The present disclosure relates to a device and system for introducing gases produced by a pressurized electrolytic cell containing mixtures of ammonium hydroxide and an electrolyte, such as sodium hydroxide, into an intake air stream of an internal combustion engine. The gases produced by electrolysis and introduced into intake stream may be, by way of example and not limitation, a mixture of hydrogen, oxygen, nitrogen and other gas species. Present embodiments are directed to a system that combines a pressurized air mechanism and a gas generator. The gas generator is fed a fluid mixture from a solution reservoir tank that holds the fluid mixture. The fluid mixture undergoes electrolysis in the gas generator, producing a gas or gas mixture that is fed back to the solution reservoir tank. The pressure mechanism then supplies air under pressure to the solution reservoir tank which pressurizes the complete system. The pressurized gas mixture is then introduced into the intake air stream of an internal combustion engine. The system may be adapted for mounting to the body or under the hood of a truck or similar vehicle and next to the intake manifold of a diesel engine.

In various embodiments, the system includes an on/off switch and amp meter. The switch may connect to the vehicle's battery. When the system is turned “on”, power is supplied to the gas generator for generating a mixture of gases. The air pressure system may include an airline connected to a vehicle's high pressure airline or to an on-board compressor system. An air pressure regulator may connect to the air line for adjusting the system pressure. The airline then connects to the solution reservoir tank for pressurizing the entire system including the gas mixture before it is introduced in the engine's air intake manifold.

The gas generator may include a generator housing that contains a plurality of spaced apart anode and cathode electrode tubes. The tubes are fed fluid from the reservoir tank and provide the electrolysis gas as output. The tubes include a number of concentric cylindrical surfaces that operate to perform electrolysis on the fluid introduced into the gas generator.

### BRIEF DESCRIPTION OF THE DRAWINGS

FIG. 1 is a schematic illustration of a combination air pressure and gas generator system in accordance with embodiments discussed herein;

FIG. 2 is a perspective illustration of an embodiment of the gas generator shown in FIG. 1;

FIG. 3 is an exploded view of the gas generator shown in FIG. 2;

FIG. 4 is a cross-sectional illustration of the gas generator shown in FIG. 2;

FIG. 5A is a perspective view of the end cap show in FIG. 3; and

FIG. 5B is a reverse perspective view of the end cap shown in FIG. 5A.

### DETAILED DESCRIPTION

FIG. 1 is a schematic illustration of a pressurized electrolysis system in accordance with embodiments discussed herein. The pressurized electrolysis system is generally identified by reference numeral 10. The pressurized electrolysis system 10 may be mounted in a system housing 12 and adapted for introducing a gas mixture under pressure to an engine. In FIG. 1, the pressurized electrolysis system 10 is shown, by way of example and not limitation, as introducing a gas mixture under pressure to an intake manifold of a turbocharged diesel engine 14. A pressurized electrolysis system 10 in accordance with this disclosure may also be used with other types of engines, such as for example, gasoline engines, diesel engines, natural gas piston driven engines, turbine driven petroleum engines, natural gas burning engines, or jet engines. The pressurized electrolysis system 10 may include an air pressure system 16 and a gas generator system 18.

The gas generator system 18 includes a solution reservoir tank 20 that holds an electrolytic solution. The gas generator system 18 is pressurized by the air pressure system 16, which connects to the solution reservoir tank 20 via the airline 54. The solution reservoir tank 20 feeds the electrolytic solution, via fluid line 28, to the gas generator 30. The gas generator 30 produces a gas or gas mixture by electrolysis of the electrolytic solution. The gas produced by the gas generator 30 is then fed back to the solution reservoir tank 20 via a gas discharge line 50. The gas, when introduced into the fluid in the tank, is cooled and scrubbed to remove any fine particulates. The cooled gas then exits the tank 20 under pressure using the air pressure system 16, to a gas line 51, which is connected to the diesel engine's intake manifold or intake adapter. From there the gas mixes with the intake air stream of the engine 14.

The electrolytic solution that is fed into the gas generator 30 by the solution reservoir tank 20 may be a mixture of ammonium hydroxide and an electrolyte. In one embodiment, the solution contains 1.0-1.5% electrolyte. The electrolyte is typically sodium hydroxide, but other suitable electrolytes may be used depending on the application. In one embodiment, the electrolytic solution includes ammonium hydroxide having a 15% ammonia base. The presence of ammonia in the electrolytic solution provides a number of advantages. In one respect, ammonium hydroxide may be advantageous because of its increased hydrogen content along with the carbon reducing capability of nitrogen, second it may also lower the freezing point of the electrolytic solution eliminating or reducing problematic temperature changes. Unlike isopropyl alcohols and other types of antifreeze, ammonia does not contain carbon. Thus, by the incorporation of ammonia in the solution mixture, carbon pollution is reduced dramatically. Also, the incorporation of ammonia makes the solution mixture less caustic on the engine and on the user who may handle the mixture. The gases produced by electrolysis of the electrolytic solution may be, by way of example and not limitation, a mixture of hydrogen, oxygen, nitrogen, and other gas species. The introduction of these gases into the intake air stream of the engine 14 has been found to enhance the combustion of diesel fuel within the engine 14.

The solution reservoir tank 20 that holds the electrolytic solution may include a solution fill port 22, a fill cap 24 in the top of the housing 12, and a solution level indicator 26 in the side of the tank 20. The solution level indicator 26 indicates a low level of solution in the system 18. The solution reservoir tank 20 typically holds from 2 to 20 gallons of fluid, but may hold smaller or larger amounts depending on the application.

The gas generator system 18 may include an on/off switch 34 for selectively applying electrical power to the gas generator 30. The on/off switch 34 may be connected to a DC power relay switch 44. When the gas generator system 18 is turned “on”, using the on/off switch 34, power is supplied to the gas generator 30 and gases are generated as described herein. The on/off switch 34 may be used for testing purposes where the engine performance with the gas generator system 18 on is compared to the engine performance with the gas generator system off.

The system 10 may include an inline breaker box 42 to protect the system 18 from power surges or power failures. The inline breaker box 42 may be connected to a vehicle's battery 36 via an electric lead 38. The inline breaker box 42 is typically rated at 50 amps, but may be rated for greater or lesser current amounts depending on the application. The inline breaker box 42 may be connected to a DC power relay switch 44 and a shunt 46. The shunt 46 may be connected to a positive pole on the gas generator 30 and an amp meter 48. The amp meter 48 may monitor the status of the electrolysis gas produced from the gas generator 30.

The DC power relay switch 44 may be connected to a manifold pressure switch 40 on the engine 14. The DC power relay switch 44 may be configured to receive a pressure signal from the manifold pressure switch 40 and to apply variable amounts of power to the gas generator 30 responsive to the pressure signal. This configuration allows the system 10 to automatically respond to the demands of the engine 14 when it is advantageous to do so. Specifically, the manifold pressure switch 40 may sense elevated or otherwise changed pressure levels within the engine 14 that indicate increased demand on the engine 14, such as when the vehicle is climbing a hill. The switch 40 may open or otherwise actuate in response to the elevated or otherwise changed pressure levels to thereby cause the DC power relay switch 44 to provide additional electrical power to the gas generator system 18 to thereby generate greater amounts of gases for use in the engine 14.

The air pressure system 16, used in combination with the gas generator system 18, may include a high pressure airline 54. The high pressure airline may connect to an airline “T” fitting 56. The fitting 56 may attach to a vehicle's high pressure air line 58, which is typically used for air brakes and/or other air applications on the vehicle. The high pressure airline 58 typically operates at 90 psi, but may operate at greater or lesser pressures depending on the application. The airline 54 may connect to an air pressure regulator 60, which is adjusted to regulate the air pressure typically in a range of 30 to 50 psi, depending on the pressure of the intake air introduced into the air intake air stream of the engine. In one embodiment, the air pressure is adjusted to be at least 10 psi and greater than the manifold intake air pressure. For example, if the intake air pressure introduced into the engine is 40 psi, then the air pressure through the air line 54 would be adjusted to be 50 psi or greater.

From the air pressure regulator 60, the adjusted pressurized air may be directed through a volume control valve 62 and through an air flow control valve solenoid 64. The volume control valve typically operates at 4 to 5 liters per minute, but may operate at greater or lesser rates depending on the application. The solenoid 64 may connect to the DC power relay 44 via electric lead 66, in one respect, to shut down the air pressure system 16, should there be a loss of air pressure to the system 10. In other respects, the DC power relay 44 may provide variable amounts of power to the solenoid 64 in response to a pressure signal form the manifold pressure switch 40. From the volume control valve 62 and the solenoid 64, the pressurized air enters the solution reservoir tank 20 to thereby pressurize the gas or gas mixture contained therein.

The air pressure system 16 may operate to pressurize the entire gas generator system 18 through the connection to the solution reservoir tank 20. In one respect, the air pressure system 16 pressurizes the gas or gas mixture that is provided to the engine 14. Specifically, the pressurized gas in the solution reservoir tank 20 exits the tank 20 and enters the gas line 51. The gas line 51 exits the housing 12 and connects to a one-way air flow valve 68 attached to the engine's air intake manifold or adapter. The pressurized gas is then mixed with the air introduced into the intake air stream of the engine 14. In another respect, the air pressure system 16 pressurizes gas generator 30. Specifically, the pressurized gas in the solution reservoir tank 20 exerts a pressure on the electrolytic solution that is also located in the solution reservoir tank 20. This pressure is transferred to the gas generator 30 as the gas generator is fed the electrolytic solution through the fluid line 28.

As mentioned above, the DC power relay 44 may provide variable amounts of power to the solenoid 64 in response to a pressure signal form the manifold pressure switch 40. Here, the air pressure system 16, as well as the gas generator system 18, can be made responsive to pressure feedback from the engine 14. Specifically, as the intake air pressure increases, the manifold pressure switch 40 energizes the DC power relay 44 opening the air control solenoid 64 and the generator power control solenoid simultaneously. As the manifold pressure increases, the system pressure increases raising the resistance level of the solution in the gas generator 30. By increasing this resistance level the amount of electrolyte needed for electrolysis to occur may be reduced. It is also noted that the stabilization of certain gas species such as hydrogen and nitrogen can be effected by pressure levels.

The gas generator 30 generally includes a generator housing 32 that contains a plurality of spaced apart anode and cathode tubes. The anode and cathode tubes are shown in greater detail in FIG. 2 through FIG. 5B. FIG. 2 is a perspective illustration of a gas generator 30 embodiment. The gas generator embodiment shown in FIG. 2 includes an elongated cylindrical body that extends between two end caps 104. As described above, the gas generator 30 may be incorporated into a system 10 such that the gas generator 30 is fed fluid from the solution reservoir tank 20 via the fluid line 28. Once in the gas generator, the fluid from the tank 20 may undergo electrolysis, producing gas or a mixture of gases that are output from the gas generator 30 via the discharge line 50. Referring to FIG. 2, the end caps 104 provide attachment points for the fluid line 28 and the discharge line 50. Thus, fluid enters through a first end cap 104 and undergoes electrolysis inside the elongated body of the gas generator 30. The gas or mixture of gases produced by the electrolysis exit the gas generator 30 through a second end 104, which is opposite from the first end cap 104.

FIG. 3 is an exploded view of the gas generator 30 shown in FIG. 2. As can be seen in FIG. 3, gas generator 30 has an asymmetrical electrode configuration that includes an anode bar 108 that extends along the central axis of the elongated cylindrical body of the gas generator 30. The anode bar 108 is surrounded by a number of concentric bipolar electrically conductive tubes 112 which function as floating bipolar electrodes that are contained within the body of the gas generator 30. A cathode tube 116 surrounds both the anode bar 108 and the tubular bipolar electrodes 112 to thereby form an exterior of the gas generator 30. The anode bar 108, the bipolar conductor tubes 112, and the cathode tube 116 provide electrically conductive surfaces that provide for electrolysis of the fluid introduced into the gas generator 30. Here, the central anode electrode 108, the surrounding concentric bipolar tubular electrodes 112, and the outer most tubular cathode electrode 116 are insulated from each other, when the solution is absent, but when the solution containing the electrolyte is present, form a series connection electrical pathway that alternates between electrodes and solution, when power is applied. The cylindrical configuration of the anode bar 108, the tubular bipolar electrodes 112, and the outer tubular cathode 116 provides an advantageous usage of surface area and, in that regard, an electrically efficient and lower temperature electrolytic reaction.

In one embodiment, the gas generator 30 has a cathode tube 116 that makes up the outer shell with an outside diameter of 1.750 inches. Here, the gas generator 30 may include four tubular bipolar electrodes 112 having the following outside diameters of: 0.75 inch, 1.0 inch, 1.25 inch, and 1.5 inch. These four tubular bipolar electrodes also have a collection of small holes 130 located near each end to aid the passage of solution or gas when present. The holes 130 are shown as being aligned for purposes of illustration and by way of example and not limitation. In certain embodiments, advantages may be gained, such as avoiding electrical arcing, by orienting the electrodes such that the holes 130 are not aligned. The central most electrode is an anode consisting of a metal bar with an outside diameter of 0.500 inch. In this construction, the tubes are spaced apart by 0.065 inch. These dimensions provide an advantageous configuration for specific concentration of electrolyte within the solution. These dimensions may be adjusted with corresponding changes in electrolyte concentration. A gas generator 30 consistent with this disclosure may have other dimensions depending on the application.

The anode bar 108 and the cathode tube 116 each provide electrical contacts for the gas generator 30. A ground contact 118 is provided as a lead or other connection point that extends from the exterior surface of the cathode tube 116. Power is provided to the gas generator 30 through an electrical contact at one end of the central anode bar 108. The central anode bar 108 the tubular bipolar electrodes 112 and the outer tubular cathode electrode 116 are insulated from one another by the mounting grooves 128 in the plastic end-caps 104. Current flows from the anode bar 108 through the dissolved electrolyte and the tubular bipolar electrodes, to the outer cathode tube 116, thus allowing electrolysis to take place.

FIG. 4 is a cross sectional illustration of the gas generator 30 embodiment shown in FIG. 2. As can be seen in FIG. 4, the end caps 104 encapsulate the ends of the anode bar 108, the bipolar conductor tubes 112 and the cathode tube 116. The anode bar 108 is centered by holes 120 in each of the end caps 104. Each hole 120 includes a countersink 122 this recessed within the hole 120. The countersink 122 provides a stopping surface for a nut and washer combination that connects the anode bar 108 to the end caps 104. The anode bar 108 may be sealed to the end caps 104 by O-rings placed in the O-ring seats 126 on each end 124 of the anode bar 108. The ends of the bipolar conductor tubes 112 are encapsulated and evenly spaced with O-rings that may be placed between the tubes 112 on each end. The cathode tube 116 is centered by being overlapped on each end by the end caps 104. The cathode tube 116 may be sealed on each end by an O-ring placed in precut grooves 128 in each end cap 104.

The ends of both the cathode tube 116 and the bipolar conductor tubes 112 may be completely encapsulated and sealed with a sealant into the end caps 104, preventing the ends of these electrodes from coming into contact with the solution. This configuration may have the advantage of lowering the current and/or power consumption of the gas generator 30, and may have the advantage of lowering the operational temperature of the electrolytic fluid. Specifically, the sealing or other equivalent protection of the ends of the electrodes may prevent the edges of the metal surfaces from focusing the electric field which could potentially result in an electrical arc. An electrical arc, if present, could potentially introduce high temperature gases, result in both electrode and cap erosion or destruction, and/or ignite gases already made by the electrolysis thus preventing hydrogen gas delivery to the exhaust port of the gas generator 30. Thus, electrical arcing may result in wasteful consumption of electrical current or, more specifically, electrical current consumption that is not utilized for gas production that gets delivered to the engine. By suppressing electrical arcing at the ends of the electrodes, disclosed embodiments may avoid these disadvantages and, in general, increase the amount of electrolysis that occurs at the electrodes.

The end caps 104 can be seen in greater detail in the enlarged perspective views of FIG. 5A and 5B. FIG. 5A is a perspective view of an end cap 104 that shows an interior facing surface including the pre-cut grooves 128. FIG. 5B is a reverse perspective view of the end cap 104 shown in FIG. 5B. FIG. 5B shows an exterior facing surface of the end cap 104. The end caps 104 are adapted to be compressed to the anode bar 108, the bipolar conductor tubes 112 and cathode tube 116. The assembly may be held together by installing studs into threaded holes in each end 124 of the anode bar 108. The studs protrude through the end cap holes 120 then washers and nuts are torqued to appropriate specifications to complete the assembly. Fittings 136 fastened to the cathode tube 116 allow fluid to flow into the bottom of the gas generator 30 and the gas to exit the top of the gas generator 30.

Embodiments discussed herein may be implemented as system or kit adapted for mounting on a vehicle or mounting under the hood and next to a vehicle's diesel engine. Embodiments provide an air pressure system incorporated into a gas generator system that may be inexpensive and/or easy to install under the hood of a truck, tractor with trailer and similar type of vehicles and next to a diesel engine. The combination of systems can also be used with mobile and stationary engines. While embodiments discussed herein used with a diesel engine, they can also be used with bio-diesel, compressed natural gas, powdered coal, and gasoline operated vehicles. Also, the systems can be used independently or in conjunction with other power sources to provide the gas mixture to other power generating systems, such as fuel cells, steam engines, and hydrogen engines or for other uses, such as heating ovens, ranges and infrared catalytic heaters. The mixture of gases introduced under pressure into the intake manifold may greatly increase vehicle mileage per gallon of fuel, may improve fuel combustion at a low combustion temperature with reduced hydrocarbon emissions, may reduce greenhouse gas emissions, and may reduce engine maintenance.

Embodiments disclosed herein may provide any of a number of advantages, including reducing fuel consumption of on and off-road diesel engines; reducing the carbon and NOX output of diesel engines on and off-road; reducing service downtime due to regeneration of the diesel particulate filters (dpf) used in the diesel industry for the reduction of carbon output; reducing the amount of electrolyte used compared to other designs thereby lowering the ph. level and increasing the life of the system; decreasing turbocharger speed and exhaust temperatures; decreasing the soot content of the diesel particulate filers used for the reduction of carbon output of diesel engines thereby reducing or eliminating the fuel consumption used to perform forced regenerations. Disclosed embodiments feature an electrolytic solution include that may not get hot enough to boil or vaporize the solution, both potentially yielding a dryer exhaust gas and less power being lost due to unnecessary heating of the solution. In cold winter environments, the need for heating may be reduced or may not be required due to the antifreeze like properties of the ammonia that is added to the solution. Furthermore, unlike prior art electrolytic generators where reversing the polarity of the electrical system and swapping the anode and cathode connection of the cylindrical gas generator yields zero or trace amounts of gas output, this may not occur in certain embodiments discussed herein.

Unlike certain prior art configurations and systems, embodiments disclosed herein reduce or minimize the need for a coolant system for the gas generator and/or for the fluid reservoir because the disclosed generator design (sealing ends of tubes) may reduce heat output. Certain embodiments may reduce or minimize the need for a reservoir or accumulator for generated gases because disclosed embodiments generate gases only on demand of the engine, varying with load on the engine. Certain embodiments may reduce or minimize the need for increased wattage to the generator in order to generate sufficient volumes of gases by curbing loss of energy in the form of heat. Certain embodiments may reduce or minimize the need for a heating system for the electrolyte solution due to the disclosed chemical composition of electrolyte (NH3-H2O). Certain embodiments reduce or minimize the need for a drying or catchment system to arrest entrained droplets of electrolyte solution in the generated gases because disclosed embodiment features low heat in the generator, cooling back through reservoir, and dry air from vehicle's air pressure system that can prevent entrainment of droplets.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed.

We claim:

1. A system, comprising
a reservoir for holding a fluid mixture;
a gas generator in fluid communication with the reservoir, the gas generator adapted to perform electrolysis on the fluid mixture to thereby produce a gas mixture; and
a pressurizer configured to pressurize the system to increase the volume of the gas mixture generated by the gas generator;
wherein the pressurized gas mixture is introduced into an intake manifold of an internal combustion engine.

2. The system of claim 1, wherein the fluid mixture includes ammonia hydroxide.

3. The system of claim 2, wherein
the ammonia hydroxide has a 15% ammonia base.

4. The system of claim 2, wherein the fluid mixture includes sodium hydroxide.

5. The system of claim 1, wherein the gas mixture generated by the gas generator is selected from the group comprising hydrogen, oxygen, and nitrogen and other gas species.

6. The system of claim 1, wherein the gas mixture is fed back into the reservoir.

7. The system of claim 1, wherein gas generator comprises
a body;
a first end cap connected a first end of the body, the first end cap having an input that receives the fluid mixture from the reservoir; and
a second end cap connected to a second end of the body, the second end cap having an output that discharges the gas mixture.

8. The system of claim 7, wherein the body of the gas generator comprises
an anode bar that extends along a central axis of the body;
a plurality of concentric bipolar conductive tubes that surround the anode bar; and
a cathode tube that surrounds the bipolar conductive tubes and forms an exterior surface of the body.

9. The system of claim 8, wherein
a ground connection extending outwardly from the cathode tube; and
a power connection disposed on an end of the anode bar.

10. The system of claim 9, wherein
the central anode electrode, the surrounding concentric bipolar tubular electrodes, and the outer most tubular cathode electrode are insulated from each other, when the solution is absent, but when the solution is present, form a series connection electrical pathway that alternates between electrodes and solution, when power is applied.

11. A gas generator, comprising
a body;
a first end cap connected a first end of the body, the first end cap having an input that receives a fluid mixture; and
a second end cap connected to a second end of the body, the second end cap having an output that discharges a gas mixture produced by electrolysis of the a fluid mixture.

12. The gas generator of claim 11, wherein the fluid mixture includes ammonia.

13. The system of claim 11, wherein the body of the gas generator comprises
an anode bar that extends along a central axis of the body;
a plurality of concentric bipolar conductive tubes that surround the anode bar; and
a cathode tube that surrounds the bipolar conductive tubes and forms an exterior surface of the body.

14. The system of claim 13, wherein
a ground connection extending outwardly from the cathode tube; and
a power connection disposed on an end of the anode bar.

15. The system of claim 14, wherein
the anode bar the bipolar conductive tubes and the cathode tube are insulated from each other such that they form a pattern of conductive surfaces that alternate between electrode and fluid when power is applied.

16. A fluid mixture for use in a gas generator that produces gas to be introduced into an intake air stream of an internal combustion engine, the fluid mixture comprising
ammonia hydroxide; and
an electrolyte.

17. The fluid mixture of claim 16, wherein
the ammonia hydroxide has a 15% ammonia base; and
the electrolyte is 1.0-1.5% of the fluid mixture.

18. The fluid mixture of claim 17, wherein the electrolyte is sodium hydroxide.
